(19) United States
(12) Patent Application Publication
(10) Pub. No.: US 2016/0231294 A1
(43) Pub. Date: Aug. 11, 2016

(54) LIQUID CHROMATOGRAPHY ANALYSIS UNIT

(71) Applicant: Agilent Technologies, Inc., Santa Clara, CA (US)

(72) Inventors: Thorsten Dressler, Mannheim (DE); Manuela Senf, Karlsruhe (DE); Armin Steinke, Ettlingen (DE); Klaus Witt, Keltern (DE)

(21) Appl. No.: 15/016,989

(22) Filed: Feb. 5, 2016

(30) Foreign Application Priority Data
Feb. 6, 2015 (GB) 1502036.5

(51) Int. Cl. G01N 30/74

(52) U.S. Cl. CPC G01N 30/74; G01N 2030/027

(57) ABSTRACT

A liquid chromatography analysis unit configured for executing a predefined liquid chromatography analysis task, wherein the liquid chromatography analysis unit comprises a sample insertion compartment configured for inserting a fluidic sample to be separated, wherein the fluidic sample is to be separated when executing the liquid chromatography analysis task, a solvent accommodation section accommodating a predefined volume of at least one predefined solvent required for executing the liquid chromatography analysis task, and a sample separation unit configured for separating the fluidic sample inserted into the sample insertion compartment upon applying a solvent and sample drive force for driving the solvent and the fluidic sample through the sample separation unit.

### RELATED APPLICATIONS

This application claims priority to UK Patent Application No. GB 1502036.5, filed Feb. 6, 2015, titled “LIQUID CHROMATOGRAPHY ANALYSIS UNIT,” the content of which is incorporated herein by reference in its entirety.

### BACKGROUND ART

The present invention relates to a liquid chromatography analysis unit, a liquid chromatography system, and a method of executing a predefined liquid chromatography analysis task.

In conventional liquid chromatography, a fluidic sample is injected into a flow path between a high pressure pump and a separation column via a complex injector. The high pressure pump then drives the injected fluidic sample and an eluent (liquid mobile phase) through conduits and the column in which separation of sample components takes place. The column may comprise a material which is capable of separating different components of the fluidic sample. Such a packing material, so-called beads which may comprise silica gel, may be filled into a column tube which may be connected to other elements by conduits. A detector located downstream of the separation column then detects separated fractions of the fluidic sample.

Operation of such a liquid chromatography apparatus supports many different sophisticated and user definable analysis procedures. However, such a liquid chromatography apparatus is technologically complex in construction and requires pronounced operation skills of a user.

### DISCLOSURE

It is an object of the invention to enable liquid chromatography sample separation in a simple way so that it can be executed even by an untrained user.

According to an exemplary embodiment of the present invention, a liquid chromatography analysis unit configured for executing a predefined liquid chromatography analysis task is provided, wherein the liquid chromatography analysis unit comprises a sample insertion compartment configured for inserting a fluidic sample to be separated, wherein the fluidic sample is to be separated when executing the liquid chromatography analysis task, a solvent accommodation section accommodating a predefined volume of at least one predefined solvent required for executing the liquid chromatography analysis task, and a sample separation unit configured for separating the fluidic sample inserted into the sample insertion compartment upon applying a solvent and sample drive force for driving the solvent and the fluidic sample through the sample separation unit.

According to another exemplary embodiment of the present invention, a liquid chromatography system is provided, wherein the liquid chromatography system comprises a liquid chromatography analysis unit having the above-mentioned features, and a base station configured for being removably coupled to the liquid chromatography analysis unit for executing the predefined liquid chromatography analysis task.

According to another exemplary embodiment of the present invention, a liquid chromatography system is provided, wherein the liquid chromatography system comprises a liquid chromatography analysis cartridge (for example having the above mentioned features), and a base station configured for being removably coupled to the liquid chromatography analysis cartridge, wherein the liquid chromatography analysis cartridge and the base station are configured for cooperating for executing a liquid chromatography analysis task.

According to yet another exemplary embodiment of the present invention, a method of executing a predefined liquid chromatography analysis task for separating a fluidic sample is provided, wherein the method comprises providing a liquid chromatography analysis unit having the above-mentioned features, inserting the fluidic sample into the sample accommodation compartment, and applying a solvent and sample drive force for driving the solvent and the inserted fluidic sample through the sample separation unit for separating the fluidic sample by executing the predefined liquid chromatography analysis task.

In the context of the present application, the term “predefined liquid chromatography analysis task” may particularly denote a very specific, not user-adaptable or user-adjustable standardized test of a fluidic sample using liquid chromatography which is defined by the interior constitution of the liquid chromatography analysis unit being prefilled with corresponding consumption materials (such as solvent, separation material, etc.) specifically adapted to a single specified predefined liquid chromatography analysis task. An example for such a predefined liquid chromatography analysis task executable by a certain liquid chromatography analysis unit is a liquid chromatography based test whether or not an orange juice sample contains an amount of fungi above or below a predefined threshold value.

According to an exemplary embodiment of the invention, a preconfigured liquid chromatography analysis unit is provided which can be used by a user (which in particular can be a user being untrained in the field of liquid chromatography) as a black box and being usable only for carrying out a very specific predefined liquid chromatography analysis task, while being incapable of carrying out other liquid chromatography analysis tasks. In an interior of this non-user adjustable liquid chromatography analysis unit, solvents and separation column may already be included which are specifically prepared for the predefined liquid chromatography analysis task. The only actions the user has to perform are to insert the fluidic sample to be tested into the sample insertion compartment, and trigger the application of a solvent and sample drive force. For example, this can be done by filling in the fluidic sample, removably coupling the liquid chromatography analysis unit with a (in particular general-purpose, i.e. not liquid chromatography analysis task specific) base station and starting the liquid chromatography run (for instance by pressing a start button). This concept of a very simple liquid chromatography test kit advantageously requires no specific skills of a user and can be executed easily even outside of a sophisticated analysis lab (for instance as a portable device, which may for example be operated by a driver of a lorry delivering orange juice to a customer and desiring to carry out a quick test for determining whether there is fungi in the delivered orange juice). Furthermore, in view of the limitation of the functionality of the liquid chromatography analysis unit to only one predefined liquid chromatography analysis task, it is sufficient to provide the liquid chromatography analysis unit with a very simple construction. Many of the complex components of a conventional liquid chromatography apparatus (such as a high-pressure pump, a robot-operated injector, complex fluidic switch valves, etc.) need not be provided according to an exemplary embodiment of the invention.

In the following, further exemplary embodiments of the liquid chromatography analysis unit, the liquid chromatography systems and the method will be explained.

According to an exemplary embodiment of the invention, the sample insertion compartment comprises a (for instance sealed) sample insertion interface configured for inserting the fluidic (in particular liquid) sample from an exterior of the liquid chromatography analysis unit into a sample accommodation volume of the sample insertion compartment. For instance, the sample insertion interface is configured for inserting the fluidic sample into the sample separation volume by a manually operable insertion tool, in particular a syringe or a pipette. The provision of a complex robot-operated injector may thereby become dispensable.

According to an exemplary embodiment of the invention, the solvent accommodation section comprises at least two predefined volumes of at least two predefined solvents and is configured so that a solvent composition in form of a mixture of the at least two predefined solvents (for instance water and an organic solvent such as acetonitrile, ACN) in accordance with a predefined temporally varying solvent gradient profile is supplied to the sample separation unit upon applying the solvent and sample drive force. Therefore, a gradient profile predefined by the types and amounts of the solvents as well as by the configuration of a mixer for mixing the solvents with a composition varying over time may be provided in accordance with a liquid chromatography gradient mode for separating the fluidic sample corresponding to the predefined liquid chromatography analysis task. Hence, no complex pump controller is necessary to carry out a gradient mode. It may be sufficient to simply apply solvent and sample drive pressure for driving solvent through the mixer and the column and sample through the column for executing the gradient based predefined liquid chromatography analysis task. Alternatively, the separation can also be carried out in an isocratic mode.

According to an exemplary embodiment of the invention, the sample separation unit is configured as sample separation column. This separation column may be specifically dimensioned and prefilled with a separation medium specifically configured of carrying out the predefined liquid chromatography analysis task.

According to an exemplary embodiment of the invention, the liquid chromatography analysis unit comprises an exterior casing enclosing at least part of the sample insertion compartment, the solvent accommodation section and the sample separation unit. The casing may circumferentially surround all components of the liquid chromatography analysis unit. The casing may be configured so that the interior of the sample insertion compartment, the solvent accommodation section and the sample separation unit are not accessible by a user. This prevents misuse of the liquid chromatography analysis unit. For example, the casing may be made of plastic.

According to an exemplary embodiment of the invention, the liquid chromatography analysis unit may be configured as an integrally formed unit which cannot be separated by a user in its components. This renders the liquid chromatography analysis unit operable by untrained users and prevents misuse.

According to an exemplary embodiment of the invention, the liquid chromatography analysis unit is configured as a cartridge, in particular as a disposable cartridge for single-use or for use for only for a limited number of times (for instance until solvent within the liquid chromatography analysis unit is empty or until a gas cartridge for generating a driving force for driving sample and solvents is empty or only for ten times). In the context of the present application, the term “cartridge” may particularly denote a cassette of a defined size and shape to be configured for being inserted into a slot of the base station and being surrounded by a solid casing or housing to protect internal components against external influences (such as mechanical load or manipulation). Such a cartridge may be configured to be inserted by a user into a correspondingly shaped and dimensioned slot of the base station.

According to an exemplary embodiment of the invention, the liquid chromatography analysis unit has dimensions of not more than 15 cm, in particular of not more than 10 cm, in each spatial direction (i.e. in x-, y- and z-direction, wherein x, y and z are orthogonal to one another). Hence, the liquid chromatography analysis unit may be compact and lightweight and may be carried by a user manually to any desired destination.

According to an exemplary embodiment of the invention, the liquid chromatography analysis unit has, integrated therein and/or removably coupleable thereto, at least part of a solvent and sample drive unit configured for generating a driving force for driving the fluidic sample in the sample insertion compartment and the at least one solvent in the solvent accommodation section to or even through the sample separation unit. In one embodiment, a longitudinally displaceable piston may be provided, either integrated in the liquid chromatography analysis unit or being attachable thereto from outside thereof. By applying a pressing force to the piston from an interior or an exterior of the liquid chromatography analysis unit, the piston may be moved forwardly to thereby press the solvents and the liquid sample through a fluidic conduit within the liquid chromatography analysis unit towards the sample separation unit. It is possible that the solvent and sample drive unit is integrated within and/or is arranged outside of the liquid chromatography analysis unit. For instance, the solvent and sample drive unit may be embodied in form of a piston and a gas generation cartridge operable by a button at an exterior surface of the liquid chromatography analysis unit.

In an embodiment of the invention, the liquid chromatography analysis unit comprises a drive unit interface configured for being coupled with an entirely exterior and separate solvent and sample drive unit configured for generating a driving force for driving the fluidic sample in the sample insertion compartment and the at least one solvent in the solvent accommodation section when the solvent and sample drive unit is coupled to the drive unit interface. In this embodiment, the solvent and sample drive unit may be a separate component or may form part of the base station and may be attached from an exterior position of the liquid chromatography analysis unit to the drive unit interface which can therefore be free of any active hardware components of the solvent and sample drive unit. In such an embodiment, the construction and weight of the liquid chromatography analysis unit is extremely simple.

According to an exemplary embodiment of the invention, the solvent and sample drive unit is configured as a mechanically actuable drive unit, a chemically actuable drive unit, a gas pressure generator, or a pneumatically actuable drive unit. For example, a mechanically actuable drive unit is a drive unit which is actuated by a mechanical force exerted by a motor or a user. For example, a chemically actuable drive unit is a drive unit which is powered by a chemical reaction which generates energy or pressure used as an energy source for applying a fluid transport force. For example, a gas pressure generator may be a gas cartridge actuable for generating overpressure which, in turn, drives a piston to displace fluid. For example, a hydraulically actuable drive unit is a drive unit in which a liquid acts as working medium. For example, a pneumatically actuable drive unit is a drive unit in which gas acts as working medium. With all these embodiments, a complex high-performance or high pressure pump may be dispensable. In contrast to this, the solvent and sample drive unit may generate a relatively small pressure, for example in a range between 1.5 bar and 20 bar.

According to an exemplary embodiment of the invention, the liquid chromatography analysis unit comprises an analysis task identifier, in particular a machine-readable analysis task identifier, configured for identifying the predefined liquid chromatography analysis task to be executed by the liquid chromatography analysis unit. For example, the analysis task identifier of the liquid chromatography analysis unit may be a barcode (in particular a one-dimensional barcode or a two-dimensional barcode), an RFID tag, a color field, or an alphanumerical code. Upon coupling the liquid chromatography analysis unit with a base station, an analysis task identification unit of the base station may automatically identify the liquid chromatography analysis task which the liquid chromatography analysis unit is capable to execute. This then allows the base station to adapt its operation to the liquid chromatography analysis task to be carried out, without requiring a user to program the base station accordingly.

According to an exemplary embodiment of the invention, the liquid chromatography analysis unit comprises at least a part of a detector configured for detecting the separated fluidic sample. For example, the part of the detector forming part of the liquid chromatography analysis unit may be a flow cell of an electromagnetic radiation based detector, at least a part of an impedance detector, and/or a detection window for externally exposing the separated fluidic sample and being transparent for electromagnetic radiation used for detecting the separated fluidic sample from an exterior of the liquid chromatography analysis unit. In particular, it is possible that a relatively simple part of the detector forms part of the liquid chromatography analysis unit, whereas a relatively complex part of the detector may form part of a corresponding base station. This allows for an efficient use of resources, in particular when the liquid lithography analysis unit is configured as a disposable or as a single use product.

According to an exemplary embodiment of the invention, the liquid chromatography analysis unit (in particular when being embodied as a cartridge) is configured for being coupled to, in particular for being at least partially insertable in, a base station cooperating with the liquid chromatography analysis unit for executing the predefined liquid chromatography analysis task. Both cartridge and base station may be configured as portable devices. In the context of the present application, the term “portable devices” shall denote devices which can be easily carried manually by an adult user.

According to an exemplary embodiment of the invention, the method further comprises selecting one of a plurality of different liquid chromatography analysis units having the above-mentioned features, each of which being configured for executing a different predefined liquid chromatography analysis task, for executing a user-selected liquid chromatography analysis task for a user-defined purpose. Hence, a set of liquid chromatography analysis cartridges may be provided each of which being configured for supporting another assigned liquid chromatography analysis task. Any of these liquid chromatography analysis units may then be used with one and the same base station, depending on which liquid chromatography analysis a user presently wishes to carry out. Hence, a single multi-purpose base station may be flexibly combined by a user for a certain liquid chromatography analysis tasks. This keeps operation simple, but nevertheless expands the functionality of the system to many different liquid chromatography analysis tasks. Via different analysis task identifiers of the different liquid chromatography analysis units, the base station may self-sufficiently detect which liquid chromatography analysis task it has to support at present. The base station may have stored in a storage device thereof operation parameters required for executing the respective liquid chromatography analysis task. After identifying a certain liquid chromatography analysis task, the base station may therefore derive the required operation data from the storage device.

According to an exemplary embodiment of the invention, the method further comprises coupling the liquid chromatography analysis unit to a base station, and subsequently executing the predefined liquid chromatography analysis task in cooperation between the liquid chromatography analysis unit and the base station. Furthermore, the method may comprise, after executing the predefined liquid chromatography analysis task, decoupling the used liquid chromatography analysis unit from the base station, subsequently coupling another liquid chromatography analysis unit having the above-mentioned features to the base station, and executing another liquid chromatography analysis task in cooperation between the other liquid chromatography analysis unit and the base station. Thus, a modular construction set of for instance one single base station and multiple different liquid chromatography analysis units serving different liquid chromatography analysis tasks flexibly allows even an untrained user to adapt the system to his or her preferences or to many different applications.

### BRIEF DESCRIPTION OF DRAWINGS

Other objects and many of the attendant advantages of embodiments of the present invention will be readily appreciated and become better understood by reference to the following more detailed description of embodiments in connection with the accompanied drawings. Features that are substantially or functionally equal or similar will be referred to by the same reference signs.

FIG. 1 illustrates a liquid chromatography system according to an exemplary embodiment of the invention comprising a liquid chromatography analysis unit and a base station.

FIG. 2 illustrates a liquid chromatography system according to another exemplary embodiment of the invention.

FIG. 3 illustrates a liquid chromatography analysis unit according to an exemplary embodiment of the invention.

FIG. 4 illustrates a set of liquid chromatography analysis units according to an exemplary embodiment of the invention.

The illustrations in the drawings are schematic.

Before, referring to the drawings, exemplary embodiments will be described in further detail, some basic considerations will be summarized based on which exemplary embodiments of the invention have been developed.

According to an exemplary embodiment, a compact HPLC (high performance liquid chromatography) analyzer cartridge is provided which can be used even by an unskilled user in a simple and flexible way.

Current standard liquid chromatography systems are huge and complicated instruments which require high education and training from the user. Many different applications are possible, but this is not always required. Errors caused by the user are easily possible.

In contrast to such complex conventional approaches, a compact liquid chromatography analyzer cartridge system according to an exemplary embodiment may be dedicated for different applications and is easy and safe to use especially from an untrained and low educated user without any HPLC background knowledge. A robust capsuled liquid chromatography analysis unit may make the conventional open handling of solvent and buffers unnecessary. All needed fluids may be built in the cartridge and may be mixed automatically, i.e. without involving the user. A traditional pump module, a traditional injection module, a traditional column compartment, as well as traditional tubes or capillaries are also not necessary according to exemplary embodiments. A liquid chromatography analysis unit configured as a compact cartridge may contain all main components for a liquid chromatography analysis which are: solvents, buffer, column, fluidic path and sample injection port. A liquid flow may be generated by a step piston which may be driven by the instrument (for example gas, compressed air or piston movement). Single and multiple injection cartridges are possible.

In one embodiment, operation of the liquid chromatography analysis unit in combination with a base station may be as follows:

1. The user puts the prepared fluidic sample, manually or by an automated system, into the liquid chromatography analysis cartridge.

2. Afterwards, the user inserts the liquid chromatography analysis cartridge into the base station (which may also be denoted as an analyzer or instrument), wherein the fluidic connections and pressure connections (if desired or required also electric connections) may be made automatically upon connection.

3. Pressure is applied to a pressure supply port of the liquid chromatography cartridge by the base station (for instance gas, compressed air or piston movement) and moves the liquids through the integrated sample separation column and connected flow path.

4. The separated fluidic sample is analyzed within the liquid chromatography cartridge or is coming out of the liquid chromatography cartridge to analyze it in an additional detection instrument.

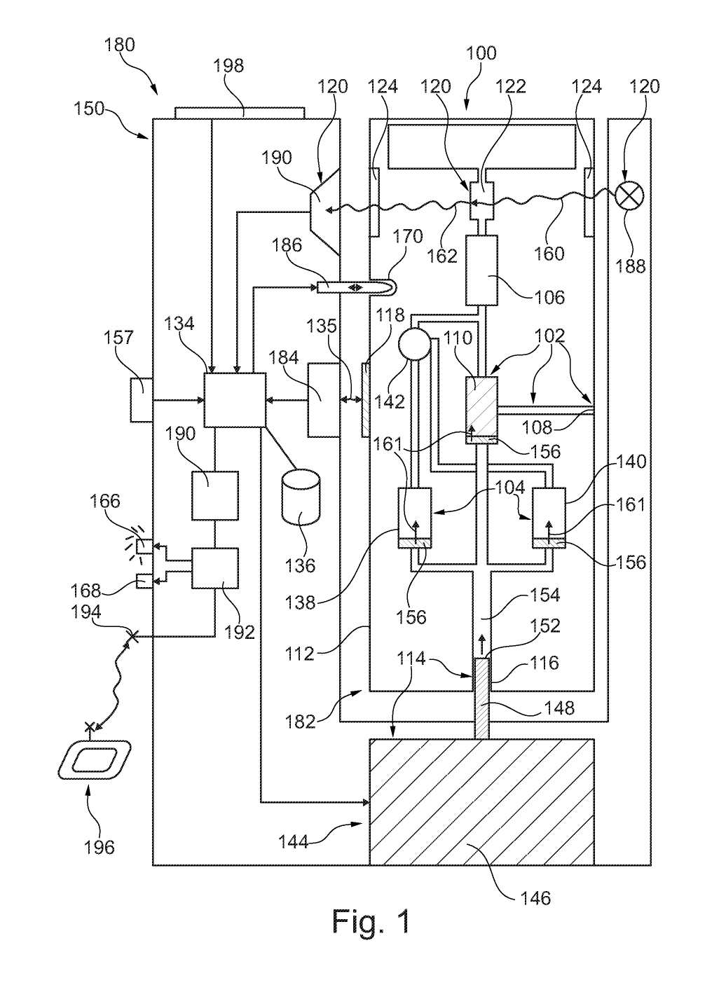

FIG. 1 illustrates a liquid chromatography system 180 according to an exemplary embodiment of the invention constituted by two selectively connectable and disconnectable components, i.e. a portable application-specific single-use cartridge-type liquid chromatography analysis unit 100 which is only capable of executing a specific predefined liquid chromatography analysis task, and a portable multiple use and multiple purpose base station 150.

The base station 150 is configured for being removably or detachably coupled to the liquid chromatography analysis unit 100 for executing the predefined liquid chromatography analysis task. For coupling the base station 150 and the liquid chromatography analysis unit 100 to one another, the cartridge-type liquid chromatography analysis unit 100 is inserted by a user into an accommodation recess or accommodation slot as an analysis unit coupling section 182 of the base station 150. A mutually corresponding shaping of the accommodation recess and the liquid chromatography analysis unit 100 ensures that a user can only correctly insert the liquid chromatography analysis unit 100 into the base station 150. Incorrect insertion of the liquid chromatography analysis unit 100 into the base station 150 may be mechanically prevented or disabled.

The liquid chromatography analysis unit 100 is configured for only executing the predefined liquid chromatography analysis task to separate a fluidic sample by executing the predefined liquid chromatography analysis task in cooperation between the base station 150 and the liquid chromatography analysis unit 100. This means that the entire configuration for the liquid chromatography analysis unit 100 in terms of solvents, separation medium, chromatographic method and output analysis result is limited to only one single liquid chromatography analysis task (for instance determination of a specific contaminant load of certain food under test). Other liquid chromatography analysis tasks are not supported by the liquid chromatography analysis unit 100. In the described embodiment, adaptation or modification of the liquid chromatography analysis task by a user is neither possible nor allowed.

The base station 150 is configured for separating a fluidic sample to be inserted into the liquid chromatography analysis unit 100 by liquid chromatography in cooperation with the presently connected liquid chromatography analysis unit 100. An analysis task identification unit 184 (here configured as RFID reader) of the base station 150 is configured for identifying the predefined liquid chromatography analysis task (i.e. the only LC based test which can be carried out using the correspondingly configured liquid chromatography analysis unit 100) supported by the liquid chromatography analysis unit 100. In view of the limited spatial detection range (compare reference numeral 135) of the analysis task identification unit 184, the task identification can only be successfully carried out when the liquid chromatography analysis unit 100 is coupled to the analysis unit coupling section 182, i.e. is properly located within the accommodation slot. In other words, in view of the limited spatial detection range of the analysis task identification unit 184, it is advantageously only capable of reading out the analysis task identifier 118 of the liquid chromatography analysis unit 100 when the latter is received within the analysis unit coupling section 182. By taking this measure, incorrect identification events of identifying unrelated liquid chromatography analysis units 100 located in the environment of the base station 150 may be prevented. The analysis task identification unit 184 determines this information by reading out an RFID tag as the analysis task identifier 118 attached to or forming part of an exterior surface of a plastic casing 112 of the liquid chromatography analysis unit 100. The RFID tag carries the information which liquid chromatography analysis task the assigned liquid chromatography analysis unit 100 is configured to carry out. When the base station 150 has derived this information by a reading operation symbolized with reference numeral 135 in FIG. 1, a control unit 134 (such as a processor) may access a database 136 (such as a data storage device) of the base station 150 to obtain control data for controlling the liquid chromatography system 180 to execute the identified liquid chromatography analysis task. Hence, in the shown embodiment, the consumables used for executing the liquid chromatography analysis task are contributed by the liquid chromatography analysis unit 100, whereas the software for controlling the liquid chromatography analysis task is contributed by the base station 150. While executing the liquid chromatography analysis task, the fluidic sample is separated under control of the control unit 134 in cooperation between the base station 150 and the liquid chromatography analysis unit 100.

The base station 150 furthermore comprises a latch or locking mechanism 186 cooperating with a correspondingly shaped locking recess 170 of the liquid chromatography analysis unit 100 and being configured for locking the liquid chromatography analysis unit 100 to the analysis unit coupling section 182 when the coupling procedure is completed. The locking mechanism 186 can be actuated (i.e.

transferred between a locked state and an unlocked state) by the control unit 134. This allows to selectively lock (during the liquid chromatography analysis) or release (during attaching or detaching the liquid chromatography analysis unit 100 with regard to the base station 150) the liquid chromatography analysis unit 100 with regard to the base station 150.

In order to enable the liquid chromatography analysis unit 100 for executing the predefined liquid chromatography analysis task, the liquid chromatography analysis unit 100 is, in the shown embodiment, equipped with all required consumables for one analysis run. The liquid chromatography analysis unit 100 comprises a sample insertion compartment 102 configured for inserting a fluidic sample to be separated. Moreover, the liquid chromatography analysis unit 100 comprises a solvent accommodation section 104 accommodating a predefined volume of different solvents required for executing the specified liquid chromatography analysis task. A sample separation unit 106 of the liquid chromatography analysis unit 100 is configured for separating the fluidic sample inserted into the sample insertion compartment 102. To start the separation procedure, it is sufficient to apply a solvent and sample drive force to the sample and the solvents within the liquid chromatography analysis unit 100 for driving the solvent and the fluidic sample through the sample separation unit 106. The sample separation unit 106 is configured as a liquid chromatography sample separation column filled with separation medium in accordance with the predefined liquid chromatography analysis task. The mentioned procedure will be explained in the following in further detail:

The sample insertion compartment 102 comprises a sample accommodation volume 110 in fluid communication with a sample insertion interface 108. The sample insertion interface 108 allows to insert the liquid sample from an exterior of the liquid chromatography analysis unit 100 via a connection channel into the sample accommodation volume 110 of the sample insertion compartment 102. Sample insertion may be accomplished by a user who may insert the fluidic sample into the sample separation volume 110 by a manually operable insertion tool such as a syringe (not shown). The amount of sample to be filled in is defined by the value of the interior volume of the sample accommodation volume 110.

The solvent accommodation section 104 comprises two containers 138, 140, each of which being filled with a respectively predefined volume of a certain solvent. In the shown embodiment, container 138 is filled with water, whereas container 140 is filled with an organic solvent such as acetonitrile (ACN). Merely by applying pressure as described below, a solvent and sample drive force is exerted so that the solvents in the containers 138, 140 are forced to flow into a mixer 142. In the mixer 142, the solvents are mixed in accordance with a predefined mixing ratio so that a defined solvent composition is generated in accordance with the liquid chromatography analysis task to be carried out. A time-dependent functionality of the mixer 142 may be predefined in such a way that a gradient profile of time-varying solvent composition is guided towards the sample separation unit 106 merely by applying constant pressure to the containers 138, 140.

The liquid chromatography analysis unit 100 furthermore comprises a plastic casing 112 circumferentially enclosing the sample insertion compartment 102, the solvent accommodation section 104 and the sample separation unit 106 while allowing fluid communication with an exterior of the liquid chromatography analysis unit 100 via the sample insertion interface 108.

The liquid chromatography analysis unit 100 comprises a drive unit interface 116 configured for being coupled with an exterior solvent and sample drive unit 114. The latter is, in turn, configured for generating a driving force for driving the fluidic sample in the sample insertion compartment 102 to flow along a predefined fluidic path within the liquid chromatography analysis unit 100 and the solvents in the solvent accommodation section 104 when the solvent and sample drive unit 114 is coupled to the drive unit interface 116. More specifically, a bottom of the base station 150 has a recess 144 in which the solvent and sample drive unit 114 is presently inserted, and from which the solvent and sample drive unit 114 may be removed. In the shown embodiment, the solvent and sample drive unit 114 comprises a gas generation cartridge 146 capable of generating gas pressure, for instance upon receipt of a trigger signal from the control unit 134. When the solvent and sample drive unit 114 is inserted into the recess 144, a gas tube 148 of the solvent and sample drive unit 114 extends into a gas supply channel 154 of the drive unit interface 116 so that generated gas with overpressure enters via a gas supply opening 152 of the gas tube 148 into gas supply channel 154 within the liquid chromatography analysis unit 100. When an overpressure is present in the gas supply channel 154, displaceable pistons 156 in the containers 138, 140 and in the sample separation volume 110 move forwardly (i.e. upwardly according to FIG. 1, see arrows 161) and thereby press the solvent and the fluidic sample through the shown fluidic conduits and subsequently into the sample separation unit 106. Fractions of the fluidic sample will be adsorbed at the sample separation unit 106, in accordance with the principle of liquid chromatography. When the solvent composition with gradient profile subsequently flows through the sample separation unit 106, the fractions will be desorbed one after the other and will flow, as separated fractions of the fluidic sample, from the sample separation unit 106 towards a flow cell 122 of a detector 120.

The detector 120, which is embodied as electromagnetic radiation based fluorescence detector, partially forms part of the liquid chromatography analysis unit 100 and partially forms part of the base station 150.

The part of the detector 120 belonging to the liquid chromatography analysis unit 100 comprises the above-mentioned flow cell 122, and comprises detection windows 124 for externally exposing the separated fluidic sample and being transparent for electromagnetic radiation used for detecting the separated fluidic sample from an exterior of the liquid chromatography analysis unit 100. The other part of the detector 120 belonging to the base station 150 comprises an electromagnetic radiation source 188 and an electromagnetic radiation detector 190 such as a fluorescence detector. The electromagnetic radiation source 188 generates a primary electromagnetic radiation beam 160 which propagates through one of the detection windows 124 and through the flow cell 122 and thereby comes in interaction with the separated fractions of the fluidic sample flowing therethrough. By the interaction with the separated fractions of the fluidic sample, a secondary electromagnetic radiation beam 162 is generated which propagates through the other detection window 124 towards the electromagnetic radiation detector 190. The electromagnetic radiation detector 190 generates a detection signal as a raw analysis result which is forwarded to the control unit 134.

The only actions a user has to take for executing the liquid chromatography analysis task are to select an appropriate liquid chromatography analysis unit 100 fulfilling this liquid chromatography analysis task, inserting the fluidic sample into the sample insertion compartment 102, inserting the cartridge-type liquid chromatography analysis unit 100 in the analysis unit coupling section 182 of the base station 150, inserting the solvent and sample drive unit 114 into the recess 144 of the base station 150 and pressing a start button 157 (or actuating any other analysis start actuator) for triggering the control unit 134 for starting the separation.

The base station 150 furthermore comprises an evaluation unit 190 configured for evaluating a result of a detection of the separated fluidic sample. For instance, the evaluation unit 190 uses the raw analysis results as received from the detector 120 and calculates or estimates an analysis result, for instance being merely indicative of whether or not a fluidic sample has passed or failed a certain test in accordance with the liquid chromatography analysis task (for instance, a food sample has passed the test when a determined contaminants load is below a predefined threshold level, and has failed the test when the determined contaminants load is above the predefined threshold level).

The base station 150 moreover comprises an output unit 192 configured for outputting a human perceivable signal indicative of a result of the separation of the fluidic sample, in the present example an optical output. The optical output is made by controlling either a green LED 166 or a red LED 168 to emit light. For instance, when the food sample has passed the test, only the green LED 166 is illuminated. When the sample has failed the test, only the red LED 168 is illuminated.

The base station 150 also comprises a communication unit 194 configured for wirelessly communicating data indicative of a result of the predefined liquid chromatography analysis task applied to the fluidic sample to a portable electronic user device 196 such as a mobile phone on which a corresponding App may be installed. The result of the test can then be displayed to the user via the electronic user device 196.

Furthermore, the base station 150 comprises a user authorization section 198 configured for carrying out a user authorization test and for rejecting execution of the liquid chromatography analysis task when the user authorization test fails. The user authorization section 198 can be embodied as a fingerprint sensor.

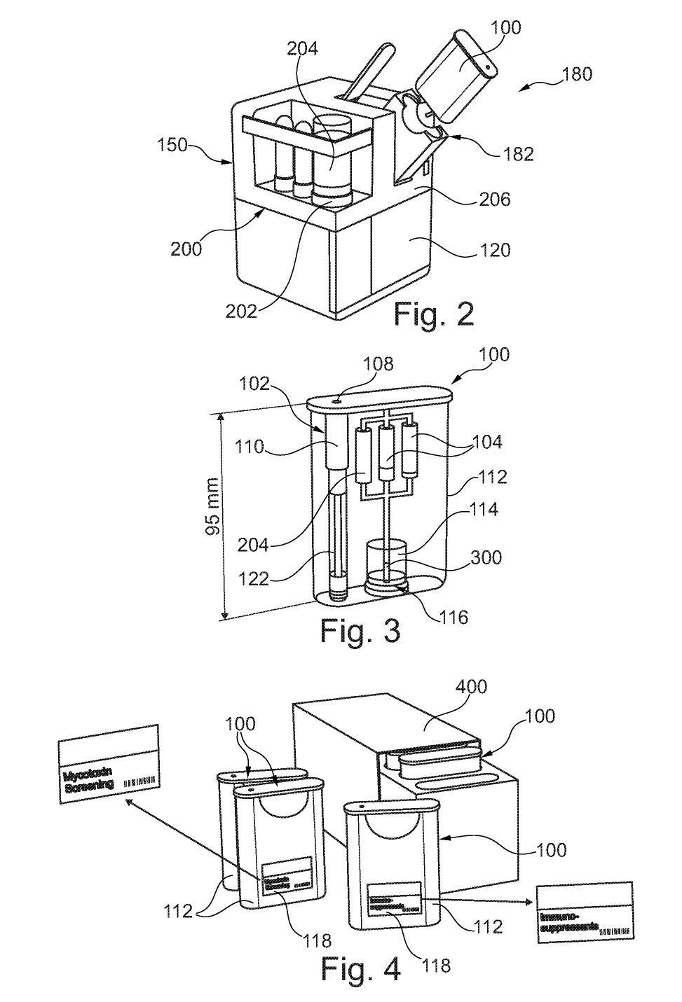

FIG. 2 illustrates a liquid chromatography system 180 according to an exemplary embodiment of the invention. In the embodiment of FIG. 2, the base station 150 comprises a detector interface 200 configured for removably mounting a detector 120 for detecting the separated fluidic sample. In the shown embodiment, the detector 120 is completely attached to the detector interface 200 of the base station 150 so that no detector components need to implemented in the cartridge-type liquid chromatography analysis unit 100. Furthermore, the base station 150 according to FIG. 2 comprises a fluid container accommodation section 202 which is configured for accommodating a buffer container 204 accommodating a buffer which can be used when executing the predefined liquid chromatography analysis task. All components of the base station 150 are mounted on or in an exterior casing 206.

FIG. 3 illustrates a liquid chromatography analysis unit 100 according to an exemplary embodiment of the invention.

According to FIG. 3, also buffer container 204 is integrated in the liquid chromatography analysis unit 100 rather than forming part of the base station 150. A height of the liquid chromatography analysis unit 100 according to FIG. 3 is 95 mm. The height constitutes the largest dimension of the compact liquid chromatography analysis unit 100.

The fluidic sample is inserted by a user via the sample insertion interface 108 configured as manual injector. The solvent and sample drive unit 114 is partially integrated in the liquid chromatography analysis unit 100 according to FIG. 3. A gas inlet constitutes the drive unit interface 116, and a step piston 300 forms part of the solvent and sample drive unit 114.

FIG. 4 illustrates a set of liquid chromatography analysis units 100 according to an exemplary embodiment of the invention.

The various liquid chromatography analysis units 100 are stored in a storage box 400. Analysis task identifiers 118 of the individual liquid chromatography analysis units 100 indicate to a user (in alphanumerical form) and a barcode reader (in form of a machine-readable barcode) which specific liquid chromatography analysis task can be executed by the respective liquid chromatography analysis unit 100.

It should be noted that the term “comprising” does not exclude other elements or features and the “a” or “an” does not exclude a plurality. Also elements described in association with different embodiments may be combined. It should also be noted that reference signs in the claims shall not be construed as limiting the scope of the claims.

1. A liquid chromatography analysis unit configured for executing a predefined liquid chromatography analysis task, wherein the liquid chromatography analysis unit comprises:
a sample insertion compartment configured for inserting a fluidic sample to be separated, wherein the fluidic sample is to be separated when executing the liquid chromatography analysis task;
a solvent accommodation section accommodating a predefined volume of at least one predefined solvent required for executing the liquid chromatography analysis task;
a sample separation unit configured for separating the fluidic sample inserted into the sample insertion compartment upon applying a solvent and sample drive force for driving the solvent and the fluidic sample through the sample separation unit.

2. The liquid chromatography analysis unit according to claim 1, wherein the sample insertion compartment comprises a sample insertion interface configured for inserting the fluidic sample from an exterior of the liquid chromatography analysis unit into a sample accommodation volume of the sample insertion compartment.

3. The liquid chromatography analysis unit according to claim 2, wherein the sample insertion interface is configured for inserting the fluidic sample into the sample separation volume by a manually operable insertion tool, in particular one of the group consisting of a syringe and a pipette.

4. The liquid chromatography analysis unit according to claim 1, wherein the solvent accommodation section comprises at least two predefined volumes of at least two predefined solvents and is configured so that a solvent composition in form of a mixture of the at least two predefined solvents in accordance with a predefined temporally varying solvent gradient profile is supplied to the sample separation unit upon applying the solvent and sample drive force.

5. The liquid chromatography analysis unit according to claim 1, wherein the sample separation unit is configured as sample separation column.

6. The liquid chromatography analysis unit according to claim 1, wherein the liquid chromatography analysis unit has, integrated therein and/or removably coupleable thereto, at least part of a solvent and sample drive unit configured for generating a driving force for driving the fluidic sample in the sample insertion compartment and the at least one solvent in the solvent accommodation section to the sample separation unit.

7. The liquid chromatography analysis unit according to claim 1, comprising a drive unit interface configured for being coupled with an at least partially exterior solvent and sample drive unit configured for generating a driving force for driving the fluidic sample in the sample insertion compartment and the at least one solvent in the solvent accommodation section to the sample separation unit when the solvent and sample drive unit is coupled to the drive unit interface.

8. The liquid chromatography analysis unit according to claim 6, wherein the solvent and sample drive unit is configured as one of the group consisting of a mechanically actuable drive unit, a chemically actuable drive unit, a gas pressure generator, and a pneumatically actuable drive unit.

9. The liquid chromatography analysis unit according to claim 1, comprising at least a part of a detector configured for detecting the separated fluidic sample.

10. The liquid chromatography analysis unit according to claim 9, wherein the part of the detector comprises at least one of the group consisting of a flow cell of an electromagnetic radiation based detector, at least a part of an impedance detector, and a detection window for externally exposing the separated fluidic sample and being transparent for electromagnetic radiation used for detecting the separated fluidic sample from an exterior of the liquid chromatography analysis unit.

11. The liquid chromatography analysis unit according to claim 1, comprising at least one feature of the group consisting of:
the liquid chromatography analysis unit is configured for being coupled to, in particular for being at least partially insertable in, a base station cooperating with the liquid chromatography analysis unit for executing the predefined liquid chromatography analysis task;
the liquid chromatography analysis unit comprises an analysis task identifier, in particular a machine-readable analysis task identifier, carrying information indicative of the predefined liquid chromatography analysis task to be executed by the liquid chromatography analysis unit;
the liquid chromatography analysis unit comprises a casing enclosing at least part of the sample insertion compartment, the solvent accommodation section and the sample separation unit;
the liquid chromatography analysis unit is configured as a cartridge, in particular as a disposable cartridge for single-use or for use for only for a limited number of times;
the liquid chromatography analysis unit has dimensions of not more than 15 cm, in particular of not more than 10 cm, in each spatial direction.

12. A liquid chromatography system, wherein the liquid chromatography system comprises:
a liquid chromatography analysis unit according to claim 1;
a base station configured for being removably coupled to the liquid chromatography analysis unit for executing the predefined liquid chromatography analysis task.

13. A liquid chromatography system, wherein the liquid chromatography system comprises:
a liquid chromatography analysis cartridge according to claim 1;
a base station configured for being removably coupled to the liquid chromatography analysis cartridge;
wherein the liquid chromatography analysis cartridge and the base station are configured for cooperating for executing a liquid chromatography analysis task.

14. The liquid chromatography system according to claim 12, wherein the base station comprises:
an analysis unit coupling section configured for removably coupling the liquid chromatography analysis unit to the base station;
an analysis task identification unit configured for identifying the predefined liquid chromatography analysis task of the liquid chromatography analysis unit coupled to the analysis unit coupling section, so that the fluidic sample is separable by executing the identified predefined liquid chromatography analysis task in cooperation between the base station and the liquid chromatography analysis unit.

15. The liquid chromatography system according to claim 14, comprising at least one of the following features:
the analysis unit coupling section comprises an accommodation slot within which at least part of the liquid chromatography analysis unit is removably accommodable;
the analysis task identification unit is configured as an identifier reader configured for reading data indicative of the predefined liquid chromatography analysis task from an analysis task identifier of the liquid chromatography analysis unit, in particular is configured as one of the group consisting of a barcode reader, more particularly a one-dimensional barcode reader or a two-dimensional barcode reader, an RFID tag reader, a color code reader, and an alphanumerical code reader;
the base station comprises a locking mechanism configured for locking the liquid chromatography analysis unit to the analysis unit coupling section;
the base station comprises a solvent and sample drive force unit configured for applying a solvent and sample drive force for driving at least one solvent and fluidic sample in the liquid chromatography analysis unit when coupled to the analysis unit coupling section;
the analysis unit coupling section is configured for coupling the liquid chromatography analysis unit to the base station by at least one of the group consisting of a mechanical coupling, a data communication coupling, an electric coupling, and a fluidic coupling.

16. The liquid chromatography system according to claim 12, comprising at least one of the following features:
the base station has dimensions of not more than 40 cm, in particular of not more than 30 cm, in each spatial direction;
the base station comprises at least a part of a detector for detecting the separated fluidic sample;
the base station comprises a detector interface configured for removably mounting at least a part of a detector for detecting the separated fluidic sample;
the base station comprises an evaluation unit configured for evaluating a result of a detection of the separated fluidic sample;
the base station comprises an output unit configured for outputting a human perceivable signal indicative of a result of the separation of the fluidic sample, in particular at least one human perceivable signal of the group consisting of an acoustic output, an optical output, and a haptic output;
the base station comprises a communication unit configured for communicating, in particular wirelessly communicating, data indicative of a result of the predefined liquid chromatography analysis task applied to the fluidic sample to an electronic user device, in particular a portable electronic user device, more particularly one of the group consisting of a mobile phone and a tablet PC;
the base station comprises a fluid container accommodation section configured for accommodating a fluid container accommodating a fluid to be used when executing the predefined liquid chromatography analysis task;
the base station comprises a user authorization section configured for carrying out a user authorization test and for rejecting execution of the liquid chromatography analysis task when the user authorization test fails.

17. A method of executing a predefined liquid chromatography analysis task for separating a fluidic sample, wherein the method comprises:
providing a liquid chromatography analysis unit according to claim 1;
inserting the fluidic sample into the sample accommodation compartment;
applying a solvent and sample drive force for driving the solvent and the inserted fluidic sample through the sample separation unit for separating the fluidic sample by executing the predefined liquid chromatography analysis task.

18. The method according to claim 17, wherein the method further comprises selecting one of a plurality of different liquid chromatography analysis units according to claim 1, each of which being configured for executing a different predefined liquid chromatography analysis task, for executing a user-selected liquid chromatography analysis task for a user-defined purpose.

19. The method according to claim 17, wherein the method further comprises:
coupling the liquid chromatography analysis unit to a base station;
subsequently executing the predefined liquid chromatography analysis task in cooperation between the liquid chromatography analysis unit and the base station.

20. The method according to claim 19, wherein the method further comprises:
after executing the predefined liquid chromatography analysis task, decoupling the liquid chromatography analysis unit from the base station;
subsequently coupling another liquid chromatography analysis unit according to claim 1 to the base station;
executing another liquid chromatography analysis task in cooperation between the other liquid chromatography analysis unit and the base station.
